(19) United States
(12) Patent Application Publication
(10) Pub. No.: US 2006/0073251 A1
(43) Pub. Date: Apr. 6, 2006

(54) System and method for nitrogen sparging of citrus juice

(76) Inventors: Jeffery P. Schroen, Cary, IL (US); Bryan W. Hitchcock, Vernon Hills, IL (US); Yongsoo Chung, Palatine, IL (US)

Correspondence Address: RYNDAK & SURI LLP, 200 W MADISON STREET, SUITE 2100, CHICAGO, IL, 60602, US

(21) Appl. No.: 11/240,135

(22) Filed: Sep. 30, 2005

Related U.S. Application Data
(63) Continuation-in-part of application No. 10/956,660, filed on Oct. 1, 2004.

(51) Int. Cl. A23C 3/037

(52) U.S. Cl. 426/474

(57) ABSTRACT

A system and method are disclosed for the processing of a citrus juice for packaging in which the juice is sparged with numerous small bubbles of nitrogen gas at one or more locations during the processing to reduce the levels of dissolved oxygen in the juice and the levels of oxygen in the packaging head space to improve the taste and sensory qualities of the citrus juice and/or to introduce turbulence to the juice. The resulting citrus juice has a dissolved oxygen level less than 0.45 ppm.

### CROSS-REFERENCE TO RELATED APPLICATION

This application is a continuation-in-part of application Ser. No. 10/956,660, filed Oct. 1, 2004, the entire disclosure of which is incorporated herein by reference.

### FIELD OF THE INVENTION

The present invention is directed to a system for and method of sparging citrus juice with nitrogen gas.

### BACKGROUND OF THE INVENTION

Citrus juices, such as orange, grapefruit, lemon and lime, which are being processed for packaging and/or storage frequently contain dissolved oxygen and volatile compounds which have off flavor notes. It is desirable to remove as much as possible of the dissolved oxygen because it tends to enter into undesirable oxidation

reactions with the citrus components which can reduce the flavor or sensory qualities of the juice particularly over extended periods of shelf storage. And of course it is desirable to remove to the extent possible any volatile compounds from the juice which might otherwise reduce the flavor and/or sensory qualities of the juice.

For these reasons, the processing of citrus juices for packaging and/or storage to date has resorted to vacuum procedures to remove dissolved oxygen and to the extent possible volatile compounds having off-notes. However, these vacuum procedures are relatively inefficient, require considerable capital expenditures for the vacuum equipment and consume large production areas of space which might otherwise be devoted to other more productive uses. Moreover, where it is desired to reduce dissolved oxygen to as low as 0.5 ppm, it has generally been necessary to heat the citrus juice during vacuum treatment to temperatures of 85-145° F. for 3-4 minutes. This not only results in increased energy consumption, but also produces some measure of thermal degradation of the citrus juice which itself produces oxidative degradation, enzymatic and non-enzymatic browning and off-notes.

### SUMMARY OF THE INVENTION

In the present invention, it has been discovered that when a citrus juice is sparged with nitrogen gas at least at one or preferably more than one location during the processing of the citrus juice for packaging and/or storage and without subjecting the juice to vacuum, the dissolved oxygen content may be significantly reduced from levels on the order of 5 ppm to levels of less than 0.45 ppm, 0.1 ppm, 0.03 ppm, and in some cases as little as 0.002 ppm. Moreover, this result is possible at temperatures as low as 35° F. and without the need to extensively heat the citrus juice as was necessary in the prior vacuum procedures if it was desired to obtain low levels of dissolved oxygen. The low levels of dissolved oxygen which are made possible by the nitrogen sparging of the present invention also will result in a reduction of the oxygen in the packaging head space on the order of 25%. The reduction of oxygen both in the citrus juice itself as well as in the packaging head space substantially improves the shelf life of the citrus juice and reduces undesirable oxidation and browning reactions during such storage which may result in the development of off-notes.

It has also been discovered that when the nitrogen sparging of the present invention is performed just preceding a pasteurization heat exchanger, the heat efficiency of the heat exchanger is increased due to the turbulence caused by the numerous small nitrogen bubbles and this turbulence reduces the energy cost of the pasteurization heat exchanger.

It has also been discovered that the nitrogen sparging of the present invention appears to remove at least some of the volatile compounds which have off-notes to result in an improvement in the flavor and/or sensory quality of the citrus juice.

In one principal aspect of the present invention, a system and method for the processing of citrus juice comprises a supply station for supplying a quantity for the citrus juice, a packaging station for packaging the citrus juice, and a passage for communicating the citrus juice from the supply station to the packaging station. A supply of nitrogen gas is provided and a sparger is associated with the passage and connected to the supply of nitrogen gas. The sparger introduces the nitrogen gas as numerous small bubbles to the citrus juice which is being communicated through the passage from the supply station to the packaging station.

In another principal aspect of the present invention, the sparger is in the passage.

In still another principal aspect of the present invention, the sparger is a sintered metal sparger.

In still another principal aspect of the present invention, the system and method include at least two tanks for holding or transferring the citrus juice, the passage communicates citrus juice between the two tanks, and the sparger introduces the nitrogen to the citrus juice in the passage between the two tanks.

In still another principal aspect of the present invention, the system and method include a pasteurization station and the sparger introduces the nitrogen to the citrus juice just preceding the pasteurization station.

In still another principal aspect of the present invention, the sparger introduces the nitrogen to the citrus juice just preceding and/or in the packaging station.

In still another principal aspect of the present invention, at least one sparger introduces the nitrogen to the citrus juice in the passage between the two tanks, another sparger introduces the nitrogen to the passage to the pasteurization station, and still another sparger delivers the nitrogen to the citrus juice preceding packaging.

These and other objects, features and advantages of the present intention will be more clearly understood through a consideration of the following detailed description.

### BRIEF DESCRIPTION OF THE DRAWINGS

In the course of this description, reference will frequently be made to the attached drawing in which:

FIG. 1 is a schematic depiction of a preferred embodiment of system of the present invention for the processing of citrus juices for packaging and which system performs the preferred embodiment of method of the present invention; and

FIG. 2 is a cross sectioned side elevation view of a conduit through which the citrus juice is communicated through the system as seen in FIG. 1 for processing, and which includes a preferred embodiment of nitrogen sparger of the present invention.

### DESCRIPTION OF THE INVENTION

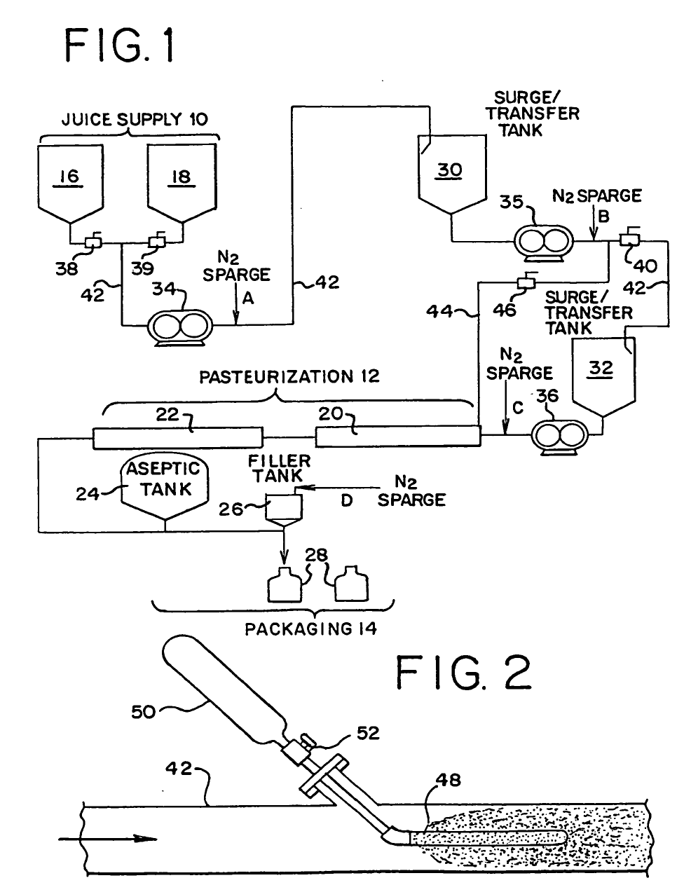

With particular reference to FIG. 1, a typical citrus juice system for processing the juice for packaging generally comprises a juice supply station 10, a pasteurization station 12 and a packaging station 14.

The juice supply station 10 typically has one or more tanks 16 and 18 as shown in FIG. 1 for holding a supply of citrus juice, such as raw orange juice. One of the tanks 16 and 18 instead of holding citrus juice may hold water and/or other fluids which are to be blended into the juice during processing. It will be appreciated that although two tanks 16 and 18 are shown, the number of tanks in the supply station 10 may vary.

The pasteurization station 12 typically includes two heat exchangers 20 and 22. The heat exchanger 20 has the purpose of heating the citrus juice prior to packaging and to a sufficient temperature and time, e.g. about 195° F. for about 5-6 seconds, to kill any bacteria that may be in the juice. Although as previously discussed in the prior vacuum procedures in which heating typically occurred which resulted in thermal degradation, that heating occurred over much longer 3-4 minute time durations. The elevated temperatures in the pasteurization process are imparted over a much shorter period which greatly minimizes the possibility of any undesirable thermal degradation of the citrus juice. However, these pasteurization times and temperatures are sufficient to insure that any undesirable bacteria are killed. After heating the citrus juice in heat exchanger 20, the juice is then immediately and rapidly cooled in heat exchanger 22 to a temperature which is sufficiently low to place it in readiness for cold packaging, e.g. about 35° F. If the juice is to be hot filled, heat exchanger 22 may be eliminated. Any one of several heat exchanger types may be employed as the heat exchangers 20 and 22, but tubular heat exchangers are generally preferred.

The packaging station 14 typically includes an aseptic tank 24 for receiving the pasteurized citrus juice and holding it under sterile conditions in readiness for packaging. When it is desired to commence packaging, a certain amount of the previously pasteurized citrus juice is communicated from the aseptic tank 24 to a filler tank 26 from which it is metered and discharged cold to the ultimate packaging 28 in which it is to be stored and ultimately marketed. The packaging 28 may include bottles or cartons of the kind which are conventionally employed in the packaging of citrus juices.

In addition to the juice supply station 10, pasteurization station 12 and packaging station 14 as just described, a typical system for processing citrus juice for packaging will include one or more surge/transfer tanks 30 and 32 as shown in FIG. 1, as well as pumps 34, 35 and 36 and control valves 38, 39 and 40 for controlling the flow through the various conduits or passages generally 42 through which the citrus juices to be communicated between components and stations of the processing system. Moreover, one or more bypass conduits, such as conduit 44 with control valve 46, may be provided to bypass some of the production line components when they are not needed or to permit maintenance.

The processing system thus far described is essentially conventional in the art for citrus processing for packaging. What is novel in the present invention and an important feature of the present invention is the discovery of the many advantages that may be realized by the sparging of the citrus juice which is being processed at one or more locations in the system with small numerous bubbles of nitrogen gas. Referring particularly to FIG. 2, the conduit 42 through which the citrus juice passes includes a sparger 48 which is coupled to a flask 50 or other suitable supply of nitrogen gas. A suitable valve 52 is preferably provided to control the flow or stop the flow of nitrogen to the sparger 48.

The sparger 48 may take any one of a number of forms including porous metals, ceramics, and the like. What is important, however, is that the sparger 48 produces a large volume of many small bubbles having a high surface area to efficiently purge the undesirable volatile compounds and dissolved oxygen from the citrus juice. The sparger uses a media. The media can be characterized by its filtration ability in a filtration test. The greater the ability of the media to remove small particles, the smaller the bubbles produced by the sparger. The sparger is capable of removing 90% of particles of 10 um size and 99% of particles of 16 um from water. Preferably, the media is capable of removing 90% of particles of 5 um size and 99% of particles of 8 um from water. Most preferably, the media is capable of removing 90% of particles of 4 um size and 99% of particles of 5.5 um from water. Preferably the media is sintered metal. Suitable spargers are available from Mott Corporation, Farmington, Conn. The described media produces small bubbles of nitrogen gas that are conducive to reducing dissolved oxygen and otherwise achieving substantial contact and permeation of the juice. As the media becomes finer, the bubbles becomes finer.

Spargers of various lengths and widths may be employed so long as they produce the large volume of numerous small bubbles desired. Spargers of 0.5 inch diameter and length of about 10 inches have been found to be effective. However, it will be appreciated that it is not intended to limit the invention to such diameter and lengths.

As previously mentioned, the sparger 48 may be located at one or more locations in the processing system. For example, referring to FIG. 1, a sparger 48 may be located at location A just after introduction from the juice supply station 10 as the citrus juice is being communicated to surge/transfer tank 30.

A sparger 48 may also be located at location B as the citrus juice is being communicated either from the surge/transfer tank 30 to the surge/transfer tank 32, or if it is being bypassed through bypass conduit 44, as it is being communicated to the pasteurization station 12.

A sparger 48 may also be located at location C as the citrus juice is being communicated from the surge transfer tank 32 to heat exchanger 20 in pasteurization station 12.

It has been found that sparging with nitrogen at location B, if bypass through conduit 44 is used and just preceding the heat exchanger 20, or at location C if the juice is not bypassed and just before the heating heat exchanger 20 is particularly effective in creating turbulence in the citrus juice. This turbulence improves efficiency of the heat exchanger. The improved efficiency can be harnessed in several different ways. First, the heat exchange surface can be decreased relative to the heat exchanger surface without sparging under the same conditions. Second, the temperature of the heating media, typically hot water or steam, used to provide the heat for pasteurization can be decreased relative to the heating media temperature without sparging under the same conditions. Either way can be used individually or in combination. Harnessing the improved efficiency also results in gentler pasteurization conditions, which improves the flavor of the juice.

A sparger 48 may also be located at location D in the packaging station 14, for example, to sparge the citrus juice in filler tank 26 just prior to its introduction to the packaging 28. It has been found that nitrogen sparging at location D in particular is highly effective to reduce the percentage of oxygen in the packaging head space.

Although nitrogen sparging at any one of the locations A-D will result in a reduction in the level of dissolved oxygen in the citrus juice and removal of volatile off- note compounds, sparging at more than one location generally results in a larger reduction.

Sparge rates can be 1-40 standard cubic feet per hour (SCFH)/gallon per minute (gpm) of citrus juice, preferably 4-20 SCFH/gpm. It has been found that nitrogen flow rates of between 2-10 SCFH per sparger through one or more spargers for juice flowrates of 0.5-2.0 gpm is capable of reducing dissolved oxygen levels from as much as 4-5 ppm in the citrus juice to less 0.45 ppm, to less than 0.1 ppm, to less than 0.03 ppm, and to even as little as 0.002 ppm. This is in contrast to levels of about 0.5 ppm which were obtained using the prior vacuum procedures. Generally, the longer the nitrogen is retained in the juice after sparging, the lower the dissolved oxygen levels will be. Nitrogen retention times of between 6-35 seconds have been found to be effective. Moreover, these significant reductions in dissolved oxygen levels can be achieved at temperatures of as low as 35° F. without the need to expose the citrus juice to thermal treatment at considerable temperatures and for periods of time as were needed in the prior vacuum procedures to attain levels only as low as 0.5 ppm. In addition, oxygen levels in the packaging head space can be reduced by as much as 25% using the nitrogen sparging of the present invention. Further, sensory analysis panels which have analyzed orange juice which has been processed in accordance with the present invention have found a statistically significant improvement in the desirable flavor quality of expressed orange oil.

The sparged nitrogen may be vented from the juice through tank vents for example. Other methods of venting are well known in the art.

Many different citrus juices can benefit from the invention including, but not limited to orange, lemon, grapefruit, mandarin, tangelo, valencia orange, navel orange, concentrate, not from concentrate and single strength.

It will be understood that the preferred embodiments of the present invention which have been described are merely illustrative of the principles of the present invention. Numerous modifications may be made by those skilled in the art without departing from the true spirit and scope of the invention.

1. A system for the processing of citrus juice comprising,
a supply station for supplying a quantity of citrus juice;
a packaging station for packaging the citrus juice;
a passage for communicating the citrus juice from said supply station to said packaging station;
a supply of nitrogen gas; and
a sparger associated with said passage and connected to said supply of nitrogen gas, said sparger introducing the nitrogen gas as numerous small bubbles to the citrus juice which is being communicated through said passage from said supply station to said packaging station.

2. The system of claim 1, wherein said sparger is in said passage.

3. The system of claim 1, wherein said sparger is a sintered metal sparger.

4. The system of claim 1, wherein said sparger uses a media capable of removing 90% of particles of 10 um size and 99% of particles of 16 um from water.

5. The system of claim 1, wherein said system includes at least two tanks for holding or transferring the citrus juice, said passage communicates the citrus juice between said two tanks, and said sparger introduces the nitrogen to the citrus juice in the passage between said two tanks.

6. The system of claim 1, wherein said system includes a pasteurization station and said sparger introduces the nitrogen to the citrus juice just preceding or in said pasteurization station.

7. The system of claim 6, wherein said pasteurization station has a heat exchange surface of reduced size compared to the heat exchange surface necessary if no sparging occurred just preceding or in said pasteurization station.

8. The system of claim 6, wherein said system further comprises a supply of heating media for pasteurization, the supply of heating media connected to the pasteurization station and having a reduced temperature compared to the temperature necessary if no sparging occurred just preceding or in said pasteurization station.

9. The system of claim 1, wherein said sparger introduces the nitrogen to the citrus juice just preceding and/or in said packaging station.

10. The system of claim 2, wherein said system includes at least two tanks for holding or transferring the citrus juice, and a pasteurization station, said passage communicates the citrus juice between said two tanks, said pasteurization station and said packaging station, and at least one said sparger introduces the nitrogen to the citrus juice in the passage between at least one of said two tanks, said pasteurization station and/or said packaging station.

11. The system of claim 6, wherein at least one said sparger introduces the nitrogen to the citrus juice in the passage between said two tanks, another said sparger introduces the nitrogen to the passage to said pasteurization station, and still another said sparger delivers the nitrogen to said packaging station.

12. A method of processing citrus juice containing substantial levels of dissolved oxygen comprising sparging the citrus juice with numerous small bubbles of gaseous nitrogen.

13. The method of claim 12, wherein the sparging uses a sintered metal sparger.

14. The method of claim 1, wherein the sparging uses a sparger having a media capable of removing 90% of particles of 10 um size and 99% of particles of 16 um from water passing through the media.

15. The method of claim 12, wherein the sparging is of citrus juice which is being communicated between two tanks.

16. The method of claim 12, including pasteurizing the citrus juice, and the sparging is performed just preceding or during the pasteurization.

17. The method of claim 16, wherein the pasteurizing is performed at reduced time or temperature conditions relative to the time or temperature conditions if no sparging occurred just preceding or during pasteurizing.

18. The method of claim 12, wherein the sparging is performed during at least one of while said citrus juice is being communicated between two tanks, just preceding pasteurization and/or packaging.

19. The method of claim 18, wherein the sparging is performed at each of the last mentioned locations.

20. A citrus juice having a dissolved oxygen concentration less than 0.45 ppm.
